(19) United States
(12) Patent Application Publication
(10) Pub. No.: US 2016/0370921 A1
(43) Pub. Date: Dec. 22, 2016

(54) LIQUID CRYSTAL GRATING, DISPLAY DEVICE AND DRIVE METHOD THEREOF

(71) Applicants: BOE TECHNOLOGY GROUP CO., LTD., Beijing (CN); CHENGDU BOE OPTOELECTRONICS TECHNOLOGY CO., LTD., Chengdu, Sichuan (CN)

(72) Inventors: Xiaomei HUANG, Beijing (CN); Benyin YE, Beijing (CN)

(73) Assignees: Boe Technology Group Co., Ltd.; Chengdu Boe Optoeletronics Technology Co., Ltd

(21) Appl. No.: 14/905,309

(22) PCT Filed: Aug. 21, 2015
(86) PCT No.: PCT/CN2015/087757

§ 371 Date: Jan. 15, 2016

(30) Foreign Application Priority Data
Feb. 15, 2015 (CN) 201510081328.5

(51) Int. Cl. G06F 3/041; G02B 27/22; G02F 1/1333; G06F 3/044; H04N 13/04; G02F 1/1343; G06F 3/047

(52) U.S. Cl. CPC G06F 3/0416; G02F 1/134309; G02F 1/13439; G02B 27/225; G06F 3/047; G06F 3/044; H04N 13/0402; H04N 13/0497; G02F 1/13338; G06F 3/0412; G02F 2201/124

(57) ABSTRACT

The present disclosure discloses a liquid crystal grating, a display device and a method of driving the display device. The liquid crystal grating comprises a first substrate, a second substrate disposed opposite to the first substrate, a liquid crystal layer arranged between the first substrate and the second substrate, a second transparent electrode layer formed on a side of the second substrate facing towards the first substrate, and a first transparent electrode layer formed on a side of the first substrate facing towards the second substrate; The present disclosure implements integration of a touch function and a two-direction autostereoscopic display function.

### CROSS REFERENCE TO RELATED APPLICATIONS

The present application is the U.S. national phase entry of PCT/CN2015/087757, with an international filing date of Aug. 21, 2015, which claims the benefit of Chinese Patent Application No. CN201510081328.5 filed with the Chinese Patent Office on Feb. 15, 2015, the entire disclosures of which are incorporated herein by reference.

### TECHNICAL FIELD

The present disclosure relates to the field of display technologies, and particularly to a liquid crystal grating, and a display device and a drive method thereof.

### BACKGROUND

Autostereoscopic or naked-eye stereoscopic display device usually employs a parallax barrier technology, wherein left and right eyes are enabled to receive different images to produce a parallax to achieve a stereoscopic display effect by providing a surface of a display screen with longitudinal grating-shaped optical barriers called “parallax barriers” to control a light travel direction. However, since an arrangement direction of the optical barriers is fixed, a stereoscopic effect cannot be presented when the display screen is rotated by 90 degrees.

A switchable liquid crystal grating may eliminate intrinsic limitations of the parallax barrier type 3D stereoscopic display device. With the switchable liquid crystal grating serving as the parallax barrier, 2D/3D display modes may be switched through the switching of the liquid crystal barrier, and arrangement of the liquid crystal barriers may be made as including a horizontal direction and a vertical direction to meet the need to switch between transverse viewing and longitudinal viewing. As shown in FIG. 1, such stereoscopic display device 100 in the prior art may comprise a TFT-LCD 101, an adhesive 102, a liquid crystal grating 103, and a backlight 104, wherein the liquid crystal grating 103 serves as a switchable parallax barrier.

However, when a touch function needs to be added to the current stereoscopic display device 100, an additional touch screen must be stuck to the stereoscopic display screen. The touch screen and the stereoscopic display screen serve as two independent display components, and need to be subjected to mask fabrication on their respective substrates, resulting in a complicated process and a high cost. In addition, a thickness of the resultant display device is large, which does not facilitate product design.

Therefore, there is a need for an improved display component, a display device using the display component, and a method for driving the display device.

### SUMMARY

It would be advantageous to integrate the touch function into the liquid crystal grating for use in a two-direction autostereoscopic display device. It would also be desirable to provide a display device having such a liquid crystal grating and a drive method thereof.

To better address one or more of these concerns, in a first aspect of the present disclosure, a liquid crystal grating is provided, comprising a first substrate, a second substrate disposed opposite to the first substrate, a liquid crystal layer arranged between the first substrate and the second substrate, a first transparent electrode layer formed on a side of the first substrate facing towards the second substrate and comprising a plurality of transparent electrode strips in a first direction; and a second transparent electrode layer formed on a side of the second substrate facing towards the first substrate and comprising a plurality of transparent electrode strips in a second direction, the second direction being perpendicular to the first direction. The transparent electrode strips in the first direction and the transparent electrode strips in the second direction are adapted to be driven by a stereoscopic display drive signal to enable the liquid crystal layer to form an grating structure in the first direction or the second direction. Additionally, the plurality of transparent electrode strips in the first direction comprise a plurality of first touch signal lines, and the plurality of transparent electrode strips in the second direction comprise a plurality of second touch signal lines the first touch signal lines and second touch signal lines being adapted to be driven by a touch drive signal to achieve touch positioning.

With the first touch signal lines (e.g., driving lines) and the transparent electrode strips in the first direction in the liquid crystal grating being used in common, and the second touch signal lines (e.g., sensing lines) and the transparent electrode strips in the second direction in the liquid crystal grating being used in common, integration of the touch function and the two-direction autostereoscopic display function may be implemented. A mask of the touch signal lines and a mask of the liquid crystal grating are combined into two mask patterns respectively for use in the first substrate and the second substrate, thereby reducing the process and lowering the cost. In addition, a dimension (e.g., thickness) of the resultant display device is reduced, thereby facilitating product design.

Optionally, the plurality of first touch signal lines comprise multiple first touch signal line groups which are arranged in parallel and independent on one another, each group comprising at least one touch signal line.

Optionally, the plurality of transparent electrode strips in the first direction further comprise a plurality of interconnected first non-touch signal lines, each of which being spaced apart from each of the plurality of first touch signal lines to form an interdigital shape.

Optionally, the first non-touch signal lines have the same line width as the first touch signal lines.

Optionally, a sum of a pitch between a first touch signal line and an adjacent first non-touch signal line and the line width is about a width of one pixel or a width of one sub-pixel.

Optionally, the plurality of second touch signal lines comprise multiple second touch signal line groups which are arranged in parallel and independent on one another, each group comprising at least one touch signal line.

Optionally, the plurality of transparent electrode strips in the second direction further comprise a plurality of interconnected second non-touch signal lines, each of which being spaced apart from each of the plurality of second touch signal lines to form an interdigital shape.

Optionally, the second non-touch signal lines have the same line width as the second touch signal lines.

Optionally, a sum of a pitch between a second touch signal line and an adjacent second non-touch signal line and the line width is about a width of one pixel or a width of one sub-pixel.

Optionally, the first touch signal lines are touch signal driving lines, and the second touch signal lines are touch signal sensing lines.

According to a second aspect of the present disclosure, there is provided a display device which comprises a display panel and a liquid crystal grating according to the first aspect of the present disclosure, wherein the liquid crystal grating is arranged at a light exit side of the display panel.

Optionally, the liquid crystal grating is arranged such that the first substrate is farther away from the display panel than the second substrate in a light exit direction of the display panel.

Optionally, the liquid crystal grating is arranged such that the second substrate is farther away from the display panel than the first substrate in a light exit direction of the display panel.

Optionally, the display device further comprises a drive chip configured to provide a touch drive signal and a stereoscopic display drive signal respectively to the liquid crystal grating in a time division manner, or provide only the touch drive signal at a predetermined time interval. The touch drive signal drives the first touch signal lines and second touch signal lines to achieve touch positioning, and the stereoscopic display drive signal drives the transparent electrode strips in the first direction and the transparent electrode strips in the second direction to enable the liquid crystal layer to form the grating structure in the first direction or second direction.

According to a third aspect of the present disclosure, there is provided a method of driving a display device according to the second aspect of the present disclosure. The method comprises: providing a touch drive signal and a stereoscopic display drive signal respectively to the liquid crystal grating in a time division manner, or providing only the touch drive signal at a predetermined time interval, wherein the touch drive signal drives the first touch signal lines and second touch signal lines to achieve touch positioning, and the stereoscopic display drive signal drives the transparent electrode strips in the first direction and the transparent electrode strips in the second direction to enable the liquid crystal layer to form the grating structure in the first direction or second direction.

Optionally, providing the touch drive signals may comprise: providing a touch control driving signal to a first plurality of groups in the multiple first touch signal line groups, providing a touch control sensing signal to a second plurality of groups in the multiple second touch signal line groups, and providing no signal to the touch signal lines in remaining groups in the multiple first touch signal line groups, the touch signal lines in remaining groups in the multiple second touch signal line groups, the first non-touch signal lines, and the second non-touch signal lines, all of which serving as virtual electrodes.

Optionally, the first plurality of groups comprise odd groups or even groups in the multiple first touch line groups, and the second plurality of groups comprise odd groups or even groups in the multiple second touch signal line groups.

Optionally, the liquid crystal layer forms the grating structure in the second direction, and providing the stereoscopic display drive signal comprises: providing a first grating driving voltage to the transparent electrode strips in the first direction, providing a second grating driving voltage cooperating with the first grating driving voltage to the second touch signal lines, and providing no signal to the second non-touch signal lines serving as virtual electrodes.

Optionally, the liquid crystal layer forms the grating structure in the first direction, and providing the stereoscopic display drive signal comprises: providing a first grating driving voltage to the first touch signal lines, providing a second grating driving voltage cooperating with the first grating driving voltage to the transparent electrode strips in the second direction, and providing no signal to the first non-touch signal lines serving as virtual electrodes.

These and other aspects of the present disclosure will be apparent from and elucidated with reference to embodiments descried below.

### BRIEF DESCRIPTION OF THE DRAWINGS

FIG. 1 schematically illustrates a sectional view of a stereoscopic display device 100 having a liquid crystal grating box 103 in the prior art;

FIG. 2 schematically illustrates a sectional view of a liquid crystal grating 200 according to an embodiment of the present disclosure; and

FIG. 3 schematically illustrates a pattern of transparent electrodes on a first substrate 201 and a second substrate 202 in the liquid crystal grating 200 according to an embodiment of the present disclosure.

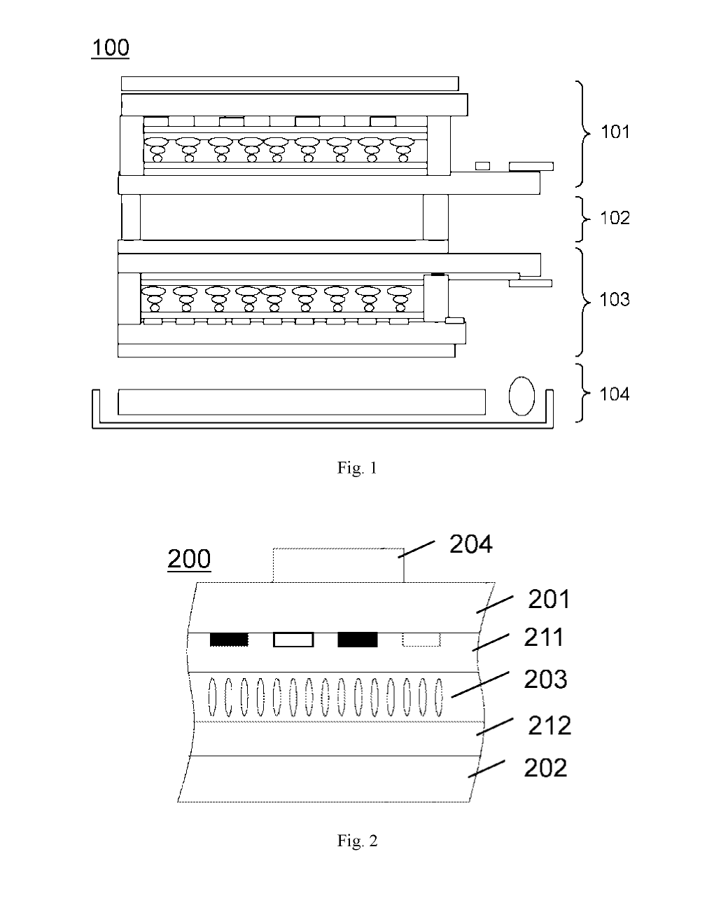

### DETAILED DESCRIPTION

Embodiments of the present disclosure will be described in detail with reference to the figures.

FIG. 2 schematically illustrates a sectional view of a liquid crystal grating 200 according to an embodiment of the present disclosure. As shown in the figure, the liquid crystal grating 200 may include a first substrate 201, a second substrate 202 disposed opposite to the first substrate 201, and a liquid crystal layer 203 between the first substrate and the second substrate. A first transparent electrode layer 211 is formed on a side of the first substrate 201 facing towards the second substrate 202. A second transparent electrode layer 212 is formed on a side of the second substrate 202 facing towards the first substrate 201. As an example, the liquid crystal layer 203 may employ TN (Twisted Nematic) type liquid crystal, which is in a normally white mode when not energized.

The first transparent electrode layer 211 may comprise a plurality of transparent electrode strips in a first direction, and the second transparent electrode layer 212 may also include a plurality of transparent electrode strips in a second direction. By way of example, the transparent electrode strips may be made of Indium-Tin Oxide (ITO) material. Generally, the second direction is perpendicular to the first direction. The transparent electrode strips in the first direction and the transparent electrode strips in the second direction are adapted to be driven by a stereoscopic display drive signal to enable the liquid crystal layer 203 to form a grating structure in the first direction or the second direction. Autostereoscopic display may be achieved in two directions (a transverse direction or longitudinal direction) by way of driving the liquid crystal grating 200 to form a grating structure in the first direction or second direction.

The transparent electrode strips in the first direction comprises a plurality of first touch signal lines, and the transparent electrode strips in the second direction comprises a plurality of second touch signal lines. The first touch signal lines and second touch signal lines are adapted to be driven by a touch drive signal to achieve touch positioning. In an example, the first touch signal lines are touch signal driving lines, and the second touch signal lines are touch signal sensing lines. As the touch signal lines and the transparent electrode strips for forming the grating structure are used in common, integration of the touch function and the autostereoscopic display function may be implemented.

It should be appreciated that in this embodiment, the touch positioning may be based on a projection capacitive touch sensing technology, which is already known in the field and thus will not be discussed here in detail. Furthermore, the liquid crystal grating 200 may further comprise members such as a polarizer, an alignment film and a rim, which are also already known in the field and thus will not be discussed here in detail. In addition, the liquid crystal grating 200 may further comprise a drive chip 204 for providing a touch drive signal to the first touch signal lines and the second touch signal lines and providing a stereoscopic display drive signal to the transparent electrodes in the first direction and transparent electrodes in the second direction (discussed in detail below). However, by way of example, and not limitation, the drive chip 204 may serve as a separate member which is separate from the liquid crystal grating 200.

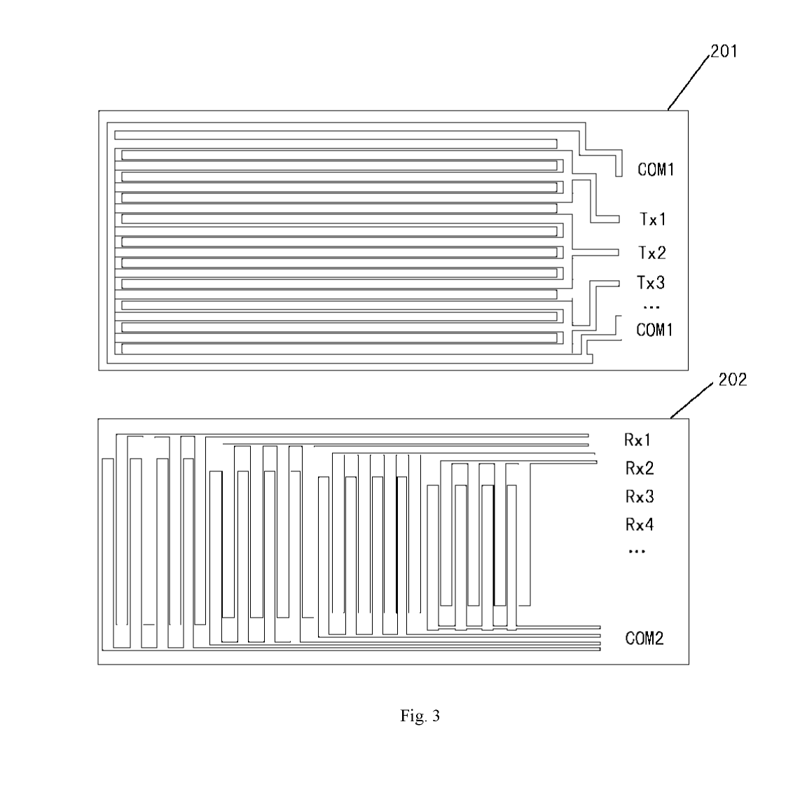

Further referring to FIG. 3, it schematically illustrates a pattern of transparent electrodes on the first substrate 201 and the second substrate 202 in the liquid crystal grating 200 according to an embodiment of the present disclosure. As shown in the figure, the first touch signal lines on the first substrate 201 comprise multiple first touch signal line groups Tx1, Tx2, Tx3 . . . which are independent on one another, each group comprising at least one touch signal line. The first touch signal line groups Tx1, Tx2, Tx3 . . . are arranged in parallel and not interleaved. In addition, the transparent electrode strips in the first direction further comprise a plurality of interconnected first non-touch signal lines COM 1. Each of the plurality of first non-touch signal lines COM 1 is spaced apart from each touch signal line in the multiple first touch signal line groups Tx1, Tx2, Tx3 . . . to form an interdigital shape. It should be appreciated that the term interconnected” herein may refer to a physical connection or a connection via a signal (e.g., by applying the same signal simultaneously).

In an example, the first non-touch signal lines COM 1 have the same line width as the touch signal lines in the first touch signal line groups Tx1, Tx2, Tx3 . . . . A slit pitch of transparent electrodes in the first direction may be employed that is identical with that of a conventional liquid crystal grating. By way of example, and not limitation, a sum of the pitch between a first touch signal line and an adjacent first non-touch signal line COM 1 and the line width may be about a width of one pixel or a width of one sub-pixel.

The second touch signal lines on the second substrate 202 comprise multiple second touch signal line groups Rx1, Rx2, Rx3, Rx4 . . . which are independent on one another, each group comprising at least one touch signal line. The second touch signal line groups Rx1, Rx2, Rx3, Rx4 . . . are arranged in parallel and not interleaved. In addition, the transparent electrode strips in the second direction further comprise a plurality of interconnected second non-touch signal lines COM 2. Each of the plurality of second non-touch signal lines is spaced apart from each touch signal line in the multiple second touch signal line groups Rx1, Rx2, Rx3, Rx4 . . . to form an interdigital shape. It should also be appreciated that the term “interconnected” herein may refer to a physical connection or a connection via a signal (e.g., by applying the same signal simultaneously).

In an example, the second non-touch signal line COM 2 has the same line width as each touch signal line in the second touch signal line groups Rx1, Rx2, Rx3, Rx4 . . . . A slit pitch of transparent electrodes in the second direction may be employed that is identical with that of a conventional liquid crystal grating. By way of example, and not limitation, a sum of the pitch between a second touch signal line and an adjacent second non-touch signal line and the line width may be about a width of one pixel or a width of one sub-pixel.

In another aspect of the present disclosure, a display device is provided which comprises a display panel and a liquid crystal grating 200 as stated above, the liquid crystal grating 200 being arranged at a light exit side of the display panel. By means of such arrangement, integration of the touch function and the two-direction autostereoscopic display function may be implemented. Specifically, the liquid crystal grating 200 may provide the display device with a touch function based on a design similar to an “in cell” structure by using in common the touch signal lines and the transparent electrode strips for forming the grating structure, and may further enable the display device to achieve transverse or longitudinal autostereoscopic display by forming the grating structure in the first direction or second direction. In addition, in the case that the liquid crystal grating 200 employs a TN type liquid crystal, since the TN type liquid crystal is in a normally white mode when not energized, such display device is used as an ordinary 2D display by making the liquid crystal grating 200 in the normally white mode (possibly at a cost of loss of certain light transmission).

In an example, the liquid crystal grating 200 may be arranged such that the first substrate 201 is farther away from the display panel than the second substrate 202 in a light exit direction of the display panel. In the case that the first touch signal lines (which are located on the first substrate 201) are touch signal driving lines, and the second touch signal lines (which are located on the second substrate 202) are touch signal sensing lines, good touch sensitivity may be achieved since the first substrate 201 is closer to a touching object upon a touch operation.

In another example, the liquid crystal grating 200 may be arranged such that the second substrate 202 is farther away from the display panel than the first substrate 201 in the light exit direction of the display panel. In this case, if the first touch signal lines are used as the touch signal driving lines and the second touch signal lines as touch signal sensing lines, the touch function can still be achieved at a cost of the loss of the touch sensitivity. Of course, in this case, in order to obtain better touch sensitivity, the second touch signal lines may be used as the touch signal driving lines and the first touch signal lines as the touch signal sensing lines so long as the drive signal provided by the drive chip (discussed below) is adjusted correspondingly.

The display device may further comprise a drive chip (e.g., the drive chip 204 as stated above). The drive chip 204 is configured to provide a touch drive signal and a stereoscopic display drive signal respectively to the liquid crystal grating 200 in a time division manner, or provide only the touch drive signal at a predetermined time interval. The touch drive signal drives the first touch signal lines and second touch signal lines to achieve touch positioning, and the stereoscopic display drive signal drives the transparent electrode strips in the first direction and the transparent electrode strips in the second direction to enable the liquid crystal layer 203 to form the grating structure in the first direction or second direction.

Correspondingly, in yet another aspect of the present disclosure, there is provided a method of driving the above display device. The method comprises: providing a touch drive signal and a stereoscopic display drive signal respectively to the liquid crystal grating in a time division manner, or providing only the touch drive signal at a predetermined time interval, wherein the touch drive signal drives the first touch signal lines and second touch signal lines to achieve touch positioning, and the stereoscopic display drive signal drives the transparent electrode strips in the first direction and the transparent electrode strips in the second direction to enable the liquid crystal layer to form the grating structure in the first direction or second direction.

In the case of providing the touch drive signal and the stereoscopic display drive signal respectively to the liquid crystal grating 200 in a time division manner, two-direction (transverse and longitudinal) switchable auto stereoscopic display device with the touch function may be implemented. For example, the touch drive signal is provided on 50% time slices, and the stereoscopic display drive signal is provided on 50% time slices, although other configurations may be employed as appropriate.

In the case of providing only the touch drive signal to the liquid crystal grating 200 at a predetermined time interval, a 2D display device with a touch function may be implemented. In this case, the liquid crystal grating 200 is in the normally white mode (which is transparent) as stated above in most time. It is to be noted that although within a time period in which the touch drive signal is present, the liquid crystal layer 203 of the liquid crystal grating 200 might form an undesired grating structure due to impact of a touch driving voltage pulse, the liquid crystal grating 200 can be made seemingly in the normally white mode all the time for the user so long as the time period is sufficiently short as not to be sensed by human eyes (due to persistence of vision). Meanwhile, detection of a touch action of the touching object is also enabled on the display device.

Providing the touch drive signal may comprise: providing a touch control driving signal to a first plurality of groups in the multiple first touch signal line groups Tx1, Tx2, Tx3, . . . , providing a touch control sensing signal to a second plurality of groups in the multiple second touch signal line groups Rx1, Rx2, Rx3, Rx4 . . . , and providing no signal to the touch signal lines in remaining groups in the multiple first touch signal line groups Tx1, Tx2, Tx3 . . . , the touch signal lines in remaining groups in the multiple second touch signal line groups Rx1, Rx2, Rx3, Rx4 . . . , the first non-touch signal lines COM 1, and the second non-touch signal lines COM 2, which instead serve as virtual electrodes.

In an example, the first plurality of groups comprise odd groups (namely, Tx1, Tx3, Tx5 . . . ) or even groups (namely, Tx2, Tx4, Tx6 . . . ) in the multiple first touch line groups Tx1, Tx2, Tx3 . . . , and the second plurality of groups comprise odd groups (namely, Rx1, Rx3 . . . ) or even groups (namely, Rx2, Rx4 . . . ) in the multiple second touch signal line groups Rx1, Rx2, Rx3, Rx4 . . . . However, it should be appreciated that the number and grouping of groups of touch signal lines in the first plurality of groups and second plurality of groups is associated with the touch resolution. A suitable configuration may be employed as appropriate.

In the cast that the grating structure in the second direction is to be formed, providing a stereoscopic display drive signal may comprise: providing a first grating driving voltage to the plurality of transparent electrode strips (namely, Tx1, Tx2, Tx3 . . . and COM 1) in the first direction, providing a second grating driving voltage cooperating with the first grating driving voltage to the second touch signal lines, and providing no signal to the second non-touch signal lines COM 2 which instead serve as virtual electrodes. In an orientation as shown in FIG. 3, assuming that the first direction is the transverse direction and the second direction is the longitudinal direction, autostereoscopic display in the transverse direction may be achieved by providing such a stereoscopic display drive signal.

In the cast that the grating structure in the first direction is to be formed, providing a stereoscopic display drive signal may comprise: providing a first grating driving voltage to the first touch signal lines, providing a second grating driving voltage cooperating with the first grating driving voltage to the plurality of transparent electrode strips (namely, Rx2, Rx4, . . . and COM 2) in the second direction, and providing no signal to the first non-touch signal lines COM 1 which instead serve as virtual electrodes. As stated above, in the orientation as shown in FIG. 3, autostereoscopic display in the longitudinal direction may be achieved by providing such a stereoscopic display drive signal.

It should be appreciated that a specific grating driving voltage for transparent electrodes on the first substrate 201 and transparent electrodes on the second substrate 202 is already known in the art, and thus will not be discussed here in detail.

While several specific implementation details are contained in the above discussions, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations are to be performed in the particular order shown or in a sequential order, or that all illustrated operations are to be performed to achieve desirable results.

Various modifications, adaptations to the foregoing exemplary embodiments of this disclosure may become apparent to those skilled in the relevant arts in view of the foregoing description, when read in conjunction with the accompanying drawings. Any and all modifications will still fall within the scope of the non-limiting and exemplary embodiments of this disclosure. Furthermore, other embodiments of the disclosures set forth herein will come to mind to one skilled in the art to which these embodiments of the disclosure pertain having the benefit of the teachings presented in the foregoing descriptions and the associated drawings.

Therefore, it is to be understood that the embodiments of the disclosure are not to be limited to the specific embodiments disclosed and that modifications and other embodiments are intended to be included within the scope of the appended claims. Although specific terms are used herein, they are used in a generic and descriptive sense only and not for purposes of limitation.

1. A liquid crystal grating, comprising:
a first substrate;
a second substrate disposed opposite to the first substrate;
a liquid crystal layer arranged between the first substrate and the second substrate;
a first transparent electrode layer formed on a side of the first substrate facing towards the second substrate and comprising a plurality of transparent electrode strips in a first direction; and
a second transparent electrode layer formed on a side of the second substrate facing towards the first substrate and comprising a plurality of transparent electrode strips in a second direction, the second direction being perpendicular to the first direction;
wherein the transparent electrode strips in the first direction and the transparent electrode strips in the second direction are adapted to be driven by a stereoscopic display drive signal to enable the liquid crystal layer to form an grating structure in the first direction or the second direction; and
wherein the plurality of transparent electrode strips in the first direction comprise a plurality of first touch signal lines, and the plurality of transparent electrode strips in the second direction comprise a plurality of second touch signal lines, the first touch signal lines and second touch signal lines being adapted to be driven by a touch drive signal to achieve touch positioning.

2. The liquid crystal grating according to claim 1, wherein the plurality of first touch signal lines comprise multiple first touch signal line groups which are arranged in parallel and independent on one another, each group comprising at least one touch signal line.

3. The liquid crystal grating according to claim 2, wherein the plurality of transparent electrode strips in the first direction further comprise a plurality of interconnected first non-touch signal lines, each of the plurality of first non-touch signal lines being spaced apart from each of the plurality of first touch signal lines to form an interdigital shape.

4. The liquid crystal grating according to claim 3, wherein the first non-touch signal lines have the same line width as the first touch signal lines.

5. The liquid crystal grating according to claim 4, wherein a sum of a pitch between a first touch signal line and an adjacent first non-touch signal line and the line width is about a width of one pixel or a width of one sub-pixel.

6. The liquid crystal grating according to claim 1, wherein the plurality of second touch signal lines comprise multiple second touch signal line groups which are arranged in parallel and independent on one another, each group comprising at least one touch signal line.

7. The liquid crystal grating according to claim 6, wherein the plurality of transparent electrode strips in the second direction further comprise a plurality of interconnected second non-touch signal lines, each of which being spaced apart from each of the plurality of second touch signal lines to form an interdigital shape.

8. The liquid crystal grating according to claim 7, wherein the second non-touch signal lines have the same line width as the second touch signal lines.

9. The liquid crystal grating according to claim 8, wherein a sum of a pitch between a second touch signal line and an adjacent second non-touch signal line and the line width is about a width of one pixel or a width of one sub-pixel.

10. The liquid crystal grating according to claim 1, wherein the first touch signal lines are touch signal driving lines, and the second touch signal lines are touch signal sensing lines.

11. The liquid crystal grating according to claim 1, wherein the transparent electrode strips are made of an Indium-Tin Oxide material.

12. A display device, comprising:
a display panel; and
a liquid crystal grating according to claim 1,
wherein the liquid crystal grating is arranged at a light exit side of the display panel.

13. The display device according to claim 12, wherein the liquid crystal grating is arranged such that the first substrate is farther away from the display panel than the second substrate in a light exit direction of the display panel.

14. The display device according to claim 12, wherein the liquid crystal grating is be arranged such that the second substrate is farther away from the display panel than the first substrate in a light exit direction of the display panel.

15. The display device according to claim 12, further comprising a drive chip configured to provide a touch drive signal and a stereoscopic display drive signal respectively to the liquid crystal grating in a time division manner, or provide only the touch drive signal at a predetermined time interval, the touch drive signal driving the first touch signal lines and second touch signal lines to achieve touch positioning, and the stereoscopic display drive signal driving the transparent electrode strips in the first direction and the transparent electrode strips in the second direction to enable the liquid crystal layer to form the grating structure in the first direction or second direction.

16. A method of driving a display device according to claim 12, comprising:
providing to the liquid crystal grating in a time division manner a touch drive signal for driving the first touch signal lines and second touch signal lines to achieve touch positioning and a stereoscopic display drive signal for driving the transparent electrode strips in the first direction and the transparent electrode strips in the second direction to enable the liquid crystal layer to form the grating structure in the first direction or second direction, respectively, or providing only the touch drive signal at a predetermined time interval.

17. The method according to claim 16, wherein the plurality of first touch signal lines comprise multiple first touch signal line groups which are arranged in parallel and independent on one another, each group comprising at least one touch signal line; the plurality of transparent electrode strips in the first direction further comprise a plurality of interconnected first non-touch signal lines each being spaced apart from each of the plurality of first touch signal lines to form an interdigital shape; the plurality of second touch signal lines comprise multiple second touch signal line groups which are arranged in parallel and independent on one another, each group comprising at least one touch signal line; and the plurality of transparent electrode strips in the second direction further comprise a plurality of interconnected second non-touch signal lines each being spaced apart from each of the plurality of second touch signal lines to form an interdigital shape; and wherein providing the touch drive signals comprises:
providing a touch control driving signal to a first plurality of groups in the multiple first touch signal line groups,
providing a touch control sensing signal to a second plurality of groups in the multiple second touch signal line groups, and
providing no signal to the touch signal lines in remaining groups in the multiple first touch signal line groups, the touch signal lines in remaining groups in the multiple second touch signal line groups, the first non-touch signal lines, and the second non-touch signal lines, all of which serving as virtual electrodes.

18. The method according to claim 17, wherein the first plurality of groups comprise odd groups or even groups in the multiple first touch line groups, and the second plurality of groups comprise odd groups or even groups in the multiple second touch signal line groups.

19. The method according to claim 17, wherein the liquid crystal layer forms the grating structure in the second direction, and wherein providing the stereoscopic display drive signal comprises:
providing a first grating driving voltage to the transparent electrode strips in the first direction,
providing a second grating driving voltage cooperating with the first grating driving voltage to the second touch signal lines, and
providing no signal to the second non-touch signal lines serving as virtual electrodes.

20. The method according to claim 17, wherein the liquid crystal layer forms the grating structure in the first direction, and wherein providing the stereoscopic display drive signal comprises:
providing a first grating driving voltage to the first touch signal lines,
providing a second grating driving voltage cooperating with the first grating driving voltage to the transparent electrode strips in the second direction, and
providing no signal to the first non-touch signal lines serving as virtual electrodes.
